(19) United States
(12) Patent Application Publication
(10) Pub. No.: US 2025/0249969 A1
(43) Pub. Date: Aug. 7, 2025

(54) TRACK ASSEMBLY ATTACHMENT FOR WHEELED VEHICLES

(71) Applicant: Dmytro Fedechko, Lviv (UA)

(72) Inventor: Dmytro Fedechko, Lviv (UA)

(21) Appl. No.: 18/857,064

(22) PCT Filed: Apr. 19, 2023
(86) PCT No.: PCT/US2023/019159

§ 371 Date: Oct. 15, 2024

Related U.S. Application Data
(60) Provisional application No. 63/333,987, filed on Apr. 22, 2022.

(51) Int. Cl. B62D 55/084; B62D 55/10; B62D 55/14; B62D 55/24

(52) U.S. Cl. CPC B62D 55/084; B62D 55/10; B62D 55/14; B62D 55/24

(57) ABSTRACT

Disclosed are track assemblies for wheeled vehicles. which improve traction and increase off-road capabilities while facilitating case of installation and removal. A track assembly can include a frame configured to receive a wheel. a first plurality of shafts supported by the frame and configured to engage with the wheel and rotate in a first direction responsive to a rotation of the wheel in an opposite second direction. a second plurality of shafts supported by the frame and configured to engage with the first plurality of shafts and rotate in the second direction responsive to the rotation of the first plurality of shafts in the first direction, and a plurality of tracks supported by the second plurality of shafts and configured to contact a surface below the wheeled vehicle and rotate in the second direction responsive to the rotation of the second plurality of shafts in the second direction.

### CROSS-REFERENCE TO RELATED APPLICATIONS

This application claims the benefit under 35 U.S.C. § 119(e) of U.S. Provisional Application No. 63/333,987, filed Apr. 22, 2022, which is incorporated by reference in its entirety.

### TECHNICAL FIELD

The present disclosure generally relates to track assembly attachments, particularly to track assembly attachments for wheeled vehicles.

### DESCRIPTION OF THE RELATED ART

Poor road and weather conditions can make it difficult for wheeled vehicles to pass through terrain. Track conversion systems can allow a vehicle to increase the off-road capabilities. Existing track conversion systems suffer from many disadvantages, including bulkiness, difficulty to install, and cost. Disclosed track assemblies address these and other shortcomings of existing systems.

### SUMMARY

A track assembly for a wheeled vehicle can include a frame configured to receive a wheel of the wheeled vehicle. The track assembly can include a first plurality of shafts and a second plurality of shafts supported by the frame. The first plurality of shafts can be configured to engage with the wheel and rotate in a first direction responsive to a rotation of the wheel in a second direction opposite to the first direction. The second plurality of shafts can be configured to engage with the first plurality of shafts and rotate in the second direction responsive to the rotation of the first plurality of shafts in the first direction. The track assembly can include a plurality of tracks supported by the second plurality of shafts. The plurality of tracks can be configured to contact a surface below the wheeled vehicle and rotate in the second direction responsive to the rotation of the second plurality of shafts in the second direction thereby improving traction of the wheel. Construction of the track assembly can facilitate rapid installation and dismounting of the track assembly on the wheeled vehicle.

The track assembly of any of the preceding paragraphs and/or any of the track assemblies disclosed herein can include one or more of the following features. The frame can form an opening configured to receive the wheeled vehicle.

The track assembly of any of the preceding paragraphs and/or any of the track assemblies disclosed herein can include one or more of the following features. The first plurality of shafts can be positioned adjacent to the opening.

The track assembly of any of the preceding paragraphs and/or any of the track assemblies disclosed herein can include one or more of the following features. The first plurality of shafts can be configured to contact the wheel. The second plurality of shafts can be configured to contact the plurality of tracks.

The track assembly of any of the preceding paragraphs and/or any of the track assemblies disclosed herein can include one or more of the following features. The track assembly can include a bar positioned adjacent to a shaft of the first plurality of shafts. The bar can be configured to prevent rotation of the shaft during installation of the wheel in the frame.

The track assembly of any of the preceding paragraphs and/or any of the track assemblies disclosed herein can include one or more of the following features. The bar can be positioned below the shaft.

The track assembly of any of the preceding paragraphs and/or any of the track assemblies disclosed herein can include one or more of the following features. The shaft can be configured to contact the bar responsive to the wheel rolling over the shaft thereby preventing rotation of the shaft.

The track assembly of any of the preceding paragraphs and/or any of the track assemblies disclosed herein can include one or more of the following features. The frame can includes a plurality of slits formed on opposite sides of the frame. The shaft can be configured to move along the plurality of slits between a first position in which the shaft contacts the bar and is prevented from rotating and a second position in which the shaft does not contact the bar and is able to rotate.

The track assembly of any of the preceding paragraphs and/or any of the track assemblies disclosed herein can include one or more of the following features. The shaft can be configured to transition to the first position as result of the wheel moving the shaft to contact the bar responsive to the wheel rolling over the shaft.

The track assembly of any of the preceding paragraphs and/or any of the track assemblies disclosed herein can include one or more of the following features. The shaft can be configured to transition to the second position as a result of the wheel pushing the shaft responsive to the wheel being positioned in an opening formed in the frame.

The track assembly of any of the preceding paragraphs and/or any of the track assemblies disclosed herein can include one or more of the following features. The shaft can be configured to move laterally along the plurality of slits.

The track assembly of any of the preceding paragraphs and/or any of the track assemblies disclosed herein can include one or more of the following features. The shaft can include an axle configured to engage with the plurality of slits.

The track assembly of any of the preceding paragraphs and/or any of the track assemblies disclosed herein can include one or more of the following features. The frame can include a top portion supporting the shaft and a bottom portion supporting the bar.

The track assembly of any of the preceding paragraphs and/or any of the track assemblies disclosed herein can include one or more of the following features. Responsive to the wheel being received in an opening of the frame, the shaft can be pressed by the wheel to engage with and cause at least one shaft of the second plurality of shafts to rotate in the second direction.

The track assembly of any of the preceding paragraphs and/or any of the track assemblies disclosed herein can include one or more of the following features. The track assembly can include a bar positioned above a track of the plurality of tracks. The bar can be configured to prevent rotation of the track during installation of the wheel in the frame.

The track assembly of any of the preceding paragraphs and/or any of the track assemblies disclosed herein can include one or more of the following features. The bar can be configured to prevent the wheel from engaging with and rotating the track during installation of the wheel in the frame.

The track assembly of any of the preceding paragraphs and/or any of the track assemblies disclosed herein can include one or more of the following features. A length of the frame can be adjustable.

The track assembly of any of the preceding paragraphs and/or any of the track assemblies disclosed herein can include one or more of the following features. The frame can include at least one first tube and at least one second tube configured to partially fit inside the at least one first tube.

The track assembly of any of the preceding paragraphs and/or any of the track assemblies disclosed herein can include one or more of the following features. The second plurality of shafts and the plurality of tracks can be configured to transition from a folded configuration to an extended configuration.

The track assembly of any of the preceding paragraphs and/or any of the track assemblies disclosed herein can include one or more of the following features. The track assembly can include a plurality of axles configured to pivot the second plurality of shafts from the folded configuration to the extended configuration.

### BRIEF DESCRIPTION OF THE DRAWINGS

The foregoing and other features of the present disclosure will become more fully apparent from the following description, taken in conjunction with the accompanying drawings. Understanding that these drawings depict only some implementations in accordance with the disclosure and are, therefore, not to be considered limiting of its scope, the disclosure will be described with additional specificity and detail through use of the accompanying drawings.

FIGS. 1-2 illustrates a track assembly.

FIG. 3 illustrates a track assembly configured to be directly mounted to a wheel.

FIGS. 4-5 and 6-8 illustrate track assemblies with a central frame.

FIGS. 9-10 illustrates a track assembly configured to be attached to a vehicle body.

FIGS. 11A-11E illustrates a track assembly with an adjustable width.

FIGS. 12-13 illustrate a track assembly with an adjustable frame.

FIGS. 14-15 and 16-17 illustrate modular track assemblies.

FIGS. 18-20 illustrate a track assembly with overlapping supporting shafts.

FIGS. 21-22 illustrate a tracks assembly with one or more additional fixing shafts.

FIGS. 23-25 illustrate a track assembly with one or more additional rolling wheels.

FIGS. 26-27 illustrates a track assembly configured to be more rigid.

FIG. 28 illustrates another track assembly configured to be more rigid.

FIG. 29 illustrates a foldable track assembly.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description and drawings are not meant to be limiting. Other approaches may be utilized, and other changes may be made, without departing from the spirit or scope of the subject matter presented here. It will be readily understood that the aspects of the present disclosure, as generally described herein, and illustrated in the figures, may be arranged, substituted, combined, and designed in a wide variety of different configurations, all of which are explicitly contemplated and made a part of this disclosure.

In particular, implementations disclosed herein pertain to track assemblies for wheeled vehicles, which improve traction and increase off-road capabilities while facilitating case of installation (or mounting or engagement) and removal (or dismounting or disengagement). Ease of installation and removal can encompass quickness and simplicity. Disclosed track assemblies can be light, durable, and compact. Wheeled vehicles described herein can include motor vehicles.

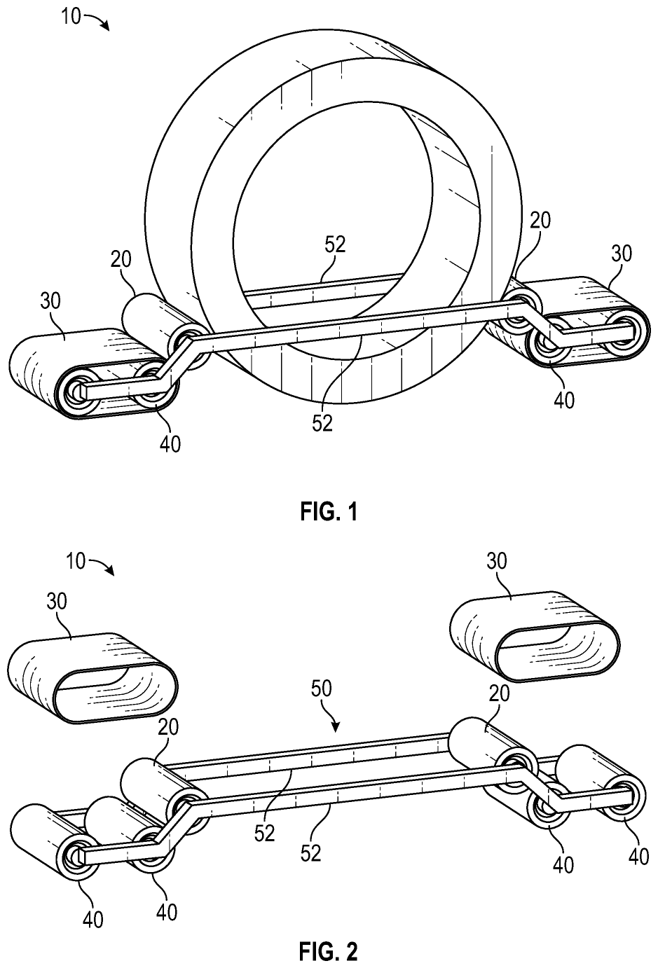

FIG. 1 illustrates a track assembly 10 configured to be attached to a wheel 15 of a wheeled vehicle (not shown). The wheel 15 can include a tire. FIG. 2 illustrates an exploded view of the track assembly 10 without the wheel 15. In operation, movement or rotation can be transferred (or transmitted) from the wheel 15 of a vehicle via one or more transmission shafts 20, thereby rotating the one or more transmission shafts 20 in the opposite direction than that in which the wheel 15 rotates. In turn, the rotation of one or more transmission shafts 20 can cause movement of one or more tracks 30 mounted on one or more supporting (or moving) shafts 40 that, in turn, would rotate in the same direction as the wheel 15. Two sets of supporting shafts 40 at front and rear of the track assembly 10 are illustrated in FIG. 2. The two sets of supporting shafts 40 support each of the two tracks 30. Each set of the supporting shafts 40 can include one or more shafts (for instance, FIGS. 1 and 2 illustrate two shafts in each set). Any of the transmission shafts 20 are configured to rotate and can function as a roller, axle, spindle, rod, bar, or the like. Any of the supporting shafts 40 are configured to rotate and can function as a roller, axle, spindle, rod, bar, or the like. For instance, any of the transmission shafts 20 or the supporting shafts 40 can be mounted on a frame 50 of the track assembly 10 via include an axle.

As shown, the frame can be sized to receive the wheel 15 in an opening of the frame. The opening can be rectangular. In some cases, one or more sides of the opening can be curved to match the curved surface of the tire of the wheel 15. As described herein, the dimensions of the frame 50 (and thus the opening) can be adjustable to accommodate wheels of different sizes. As is illustrated, the transmission shafts 20 can be positioned adjacent to the opening so that the wheel 15 contacts the transmission shafts 20 when the track assembly 10 is installed on the wheel.

The tracks 30 can be configured to provide improved traction on difficult to pass surfaces, such as snow, ice, mud, rocks, sand, or the like. The tracks 30 can be made out of material and have external surfaces that provide improved traction. For example, the tracks 30 can be made from rubber or other material of suitable flexibility (for instance, rubber that maintains flexibility is cold weather for driving in the snow or ice) As another example, the tracks 30 can be made from rubber or other material with suitable exterior tread pattern to maximize traction (such as, deeper tread depths, for instance at least 3.5 mm with increased slots and slits for driving in the snow or ice or tread depth of at least 25 mm for driving in the mud). As yet another example, the tracks 30 can include studs or spikes, which can be made out of metal. This can be advantageous for driving in the snow or on ice. The tracks 30 can have a suitable width for the type of surface (such as, narrower width for snow or ice).

The track assembly 10 can include two parts (front and rear) with tracks and shafts before and after the wheel (relative to the direction of the vehicle movement). Front and rear parts of the track assembly 10 can be connected by one or more connections 52, which can be flexible or rigid. The one or more connections 52 can be part of the frame 50.

Advantageously, the track assembly 10 can be easy to install and dismount. The track assembly 10 can be laid on a surface and the vehicle can be driven over the track assembly 10 such that the wheel 15 is positioned between the front and rear parts and is contact with the one or more transmission shafts 20. As explained herein, the one or more connections 52 can be adjustable to accommodate wheels of different sizes and to facilitate a tight fit of the track assembly 10 on the wheel 15.

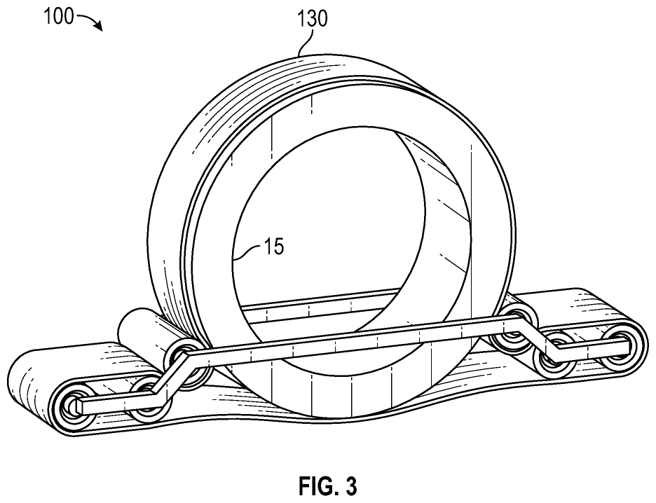

In a track assembly 100 illustrated in FIG. 3, a track 130 can be directly mounted on the wheel 15. Accordingly, a single track 130 can be used for the front and rear parts. Advantageously, this can help to prevent detachment of the track assembly from the wheel 15 during operation. The track assembly 100 can be similar to any of the track assemblies described herein.

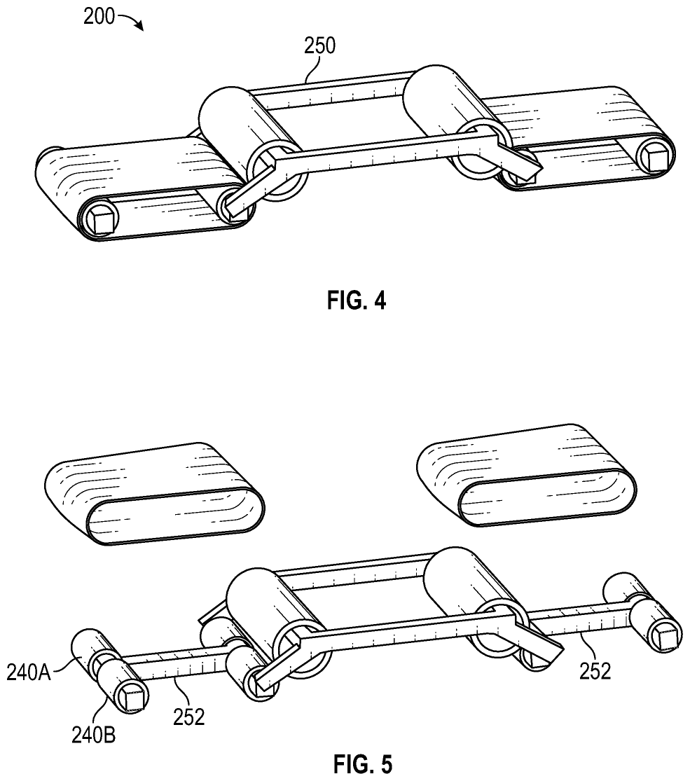

A track assembly 200 illustrated in FIG. 4 and FIG. 5 (illustrating an exploded view of the track assembly 200) can be similar to the track assembly 10 and include a central frame 250. Portions 252 of the central frame 250 can connect to supporting shafts 40 in the middle by splitting the supporting shafts into two portions 240A and 240B (such as, two halves). The track assembly 200 can be similar to any of the track assemblies described herein. Any of the track assemblies described herein can include the central frame 250.

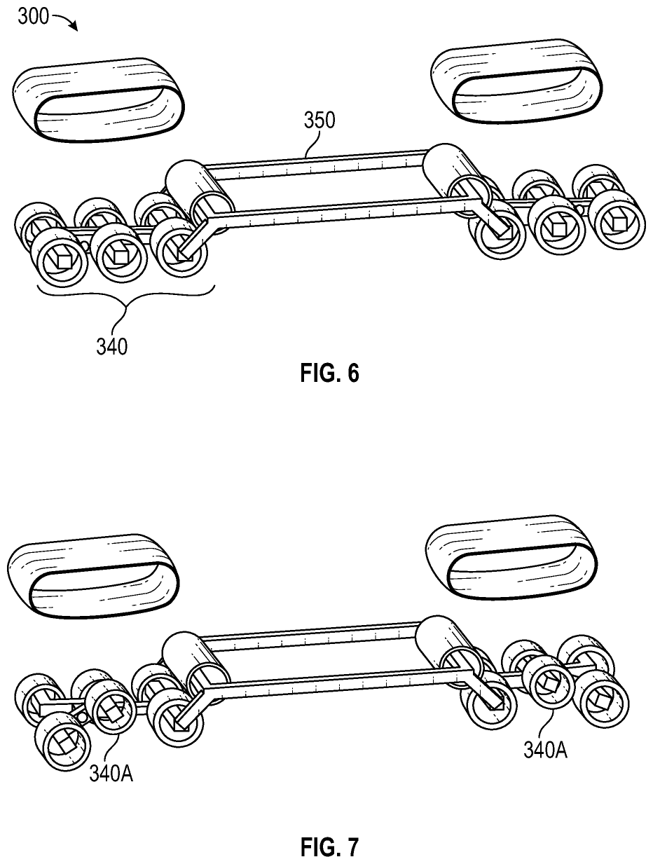

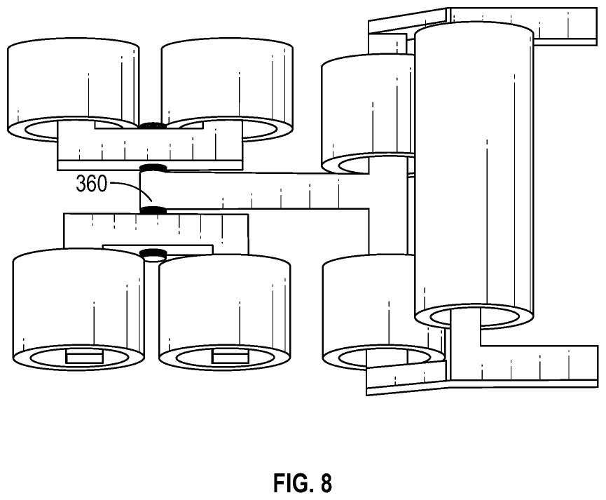

A track assembly 300 illustrated in FIGS. 6 to 7 and FIG. 8 (illustrating a top view of the track assembly 300) can include a central frame 350 with separate supporting shafts 340 on a non-stationary (or moving) sub-frame 360. Three such supporting shafts 340 are illustrated on each side of the track assembly 300. A middle supporting shaft of the supporting shafts 340 can be non-stationary. For instance, the middle supporting shaft can pivot vertically or rotate around the z-axis. As shown in FIG. 7, the middle supporting shaft 340A can pivot (or move) vertically. This can be advantageous on an uneven surface when, for instance, a rock is encountered. The illustrated arrangement can help to keep consistent pressure and traction on an uneven surface. The track assembly 300 can be similar to any of the track assemblies described herein. For instance, the central frame 350 can be similar to the central frame 250.

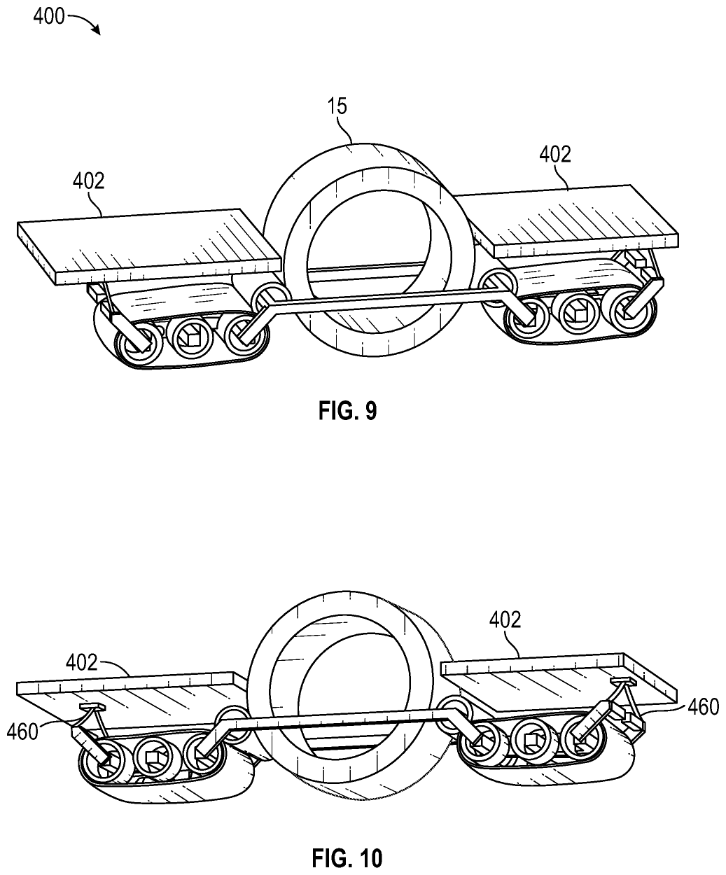

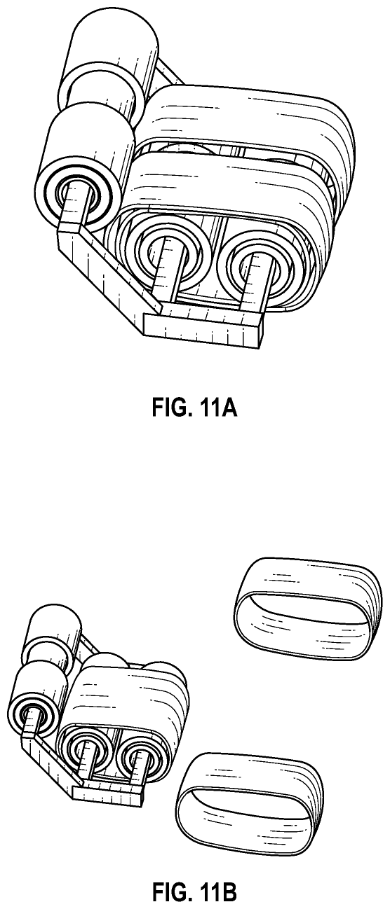

FIG. 9 illustrates a perspective front view and FIG. 10 illustrates a perspective bottom view of a track assembly 400 configured to be attached to the body 402 of a vehicle (such as, the bottom surface of the vehicle) with one or more attachments 460. The one or more attachments 406 can be made from elastic material that can stretch. Attachment to the body 402 of the vehicle can ensure that the assembly stays in place on an uneven surface and prevent detachments of the track assembly 400 form the wheel 15. The track assembly 400 can be similar to any of the track assemblies described herein.

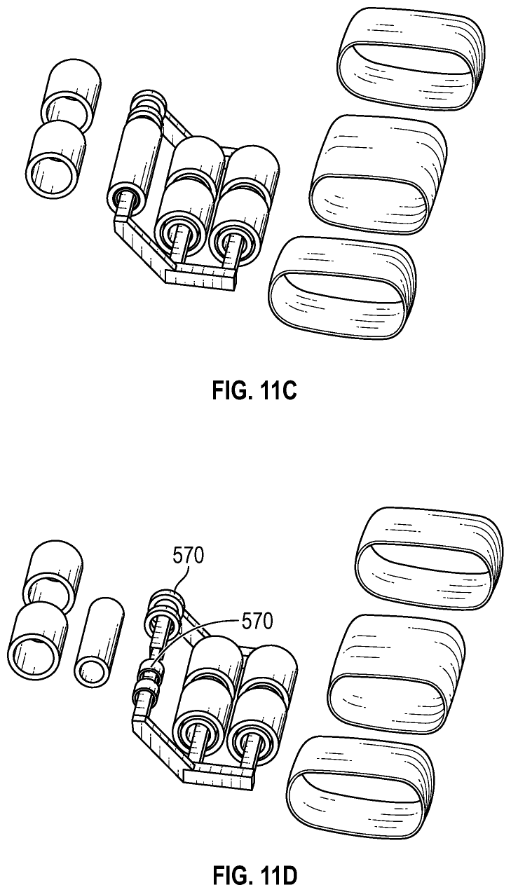

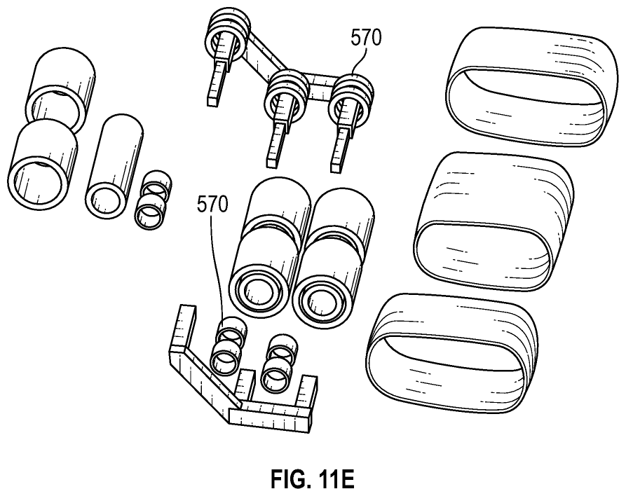

FIG. 11A illustrates a track assembly 500 configured to have an adjustable (or extendible) width. This can facilitate use with wheels or tires having different widths. FIGS. 11B to 11E illustrate various exploded views of the track assembly 500. Overlapping tracks can be positioned on extendible length supporting shafts of the track assembly 500. Such extensible length shafts can be obtained from a combination of tubes with different diameters fitting into one another along the central axis (and with dimensions that allow fitting into one another). One or more transmission shafts can also be extendible. Bearings 570 can have different sizes, as is illustrated. In certain implementations, the bearings may be not separately depicted where they are self-evident. The track assembly 500 can be similar to any of the track assemblies described herein.

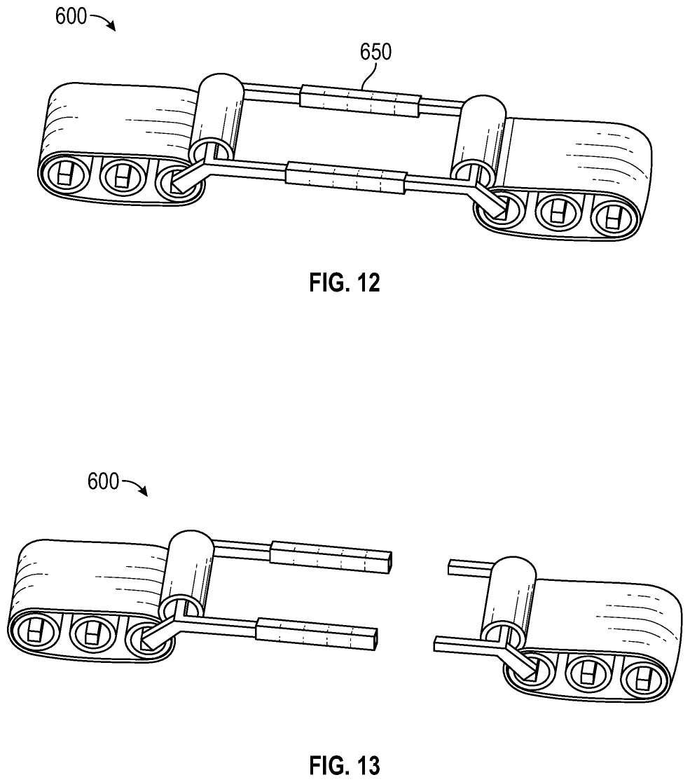

FIGS. 12 and 13 illustrate a track assembly 600 with an adjustable frame 650. The length of the frame 650 can be adjustable (or extendible). The track assembly 600 can include one or more tubes with different dimensions to fix the frame 650 in various positions. Such tubes can be telescopic tubes (or tubes that fit into one another). The tubes can be similar to the connections 52. The track assembly 600 can be similar to any of the track assemblies described herein.

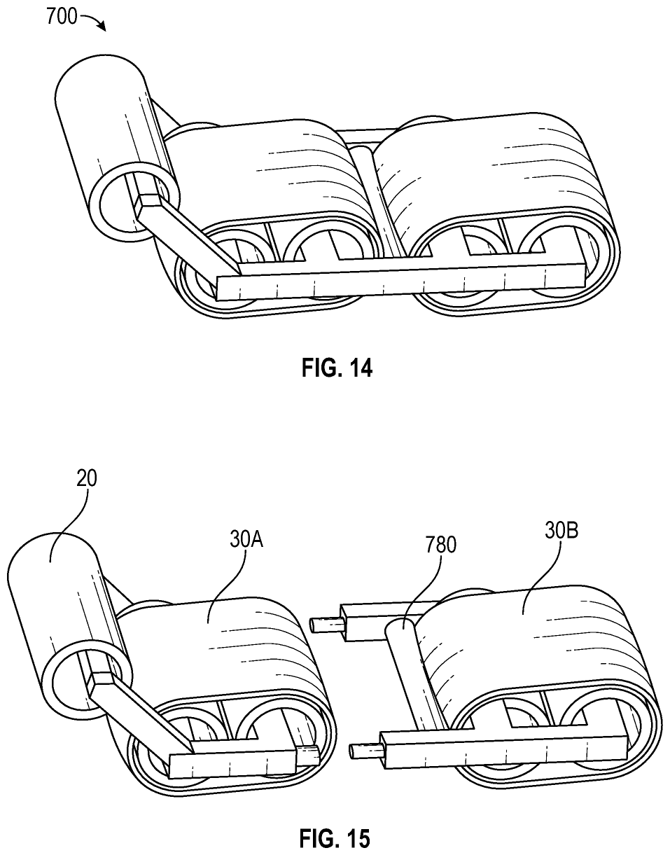

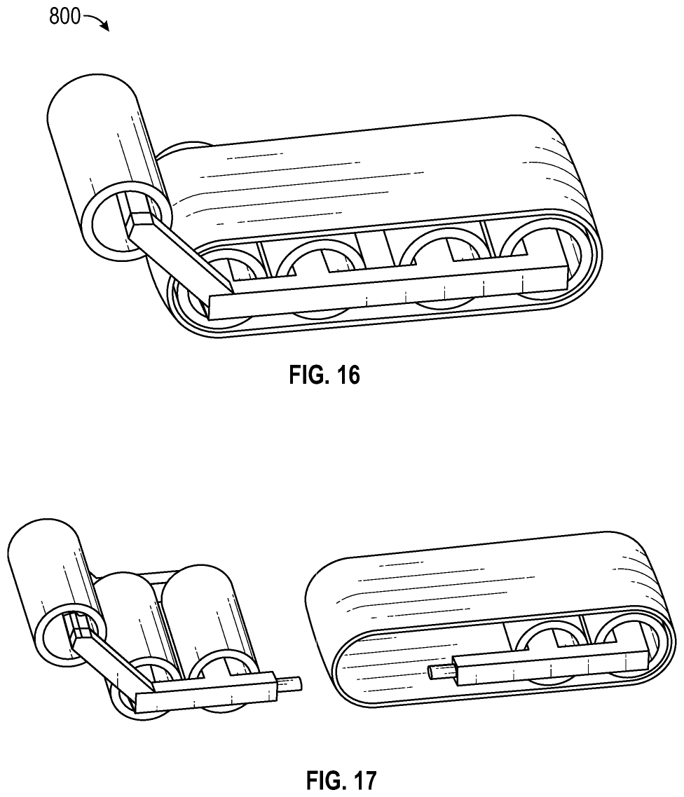

FIGS. 14 and 15 illustrate a track assembly 700 that is modular. Such arrangement allows for mounting of additional sections (for instance, to overlap a greater portion of the wheel, overlap the entire wheel, or extend beyond the wheel). Accordingly, off-road performance can be improved. The track assembly 700 can include a central transmission shaft 780 and separate tracks 30A and 30B. The track assembly 700 can be similar to any of the track assemblies described herein. In operation, the transmission shaft 20 rotates the track 30A. Central transmission shaft 780 is being rotated by the track 30A that, in turn, rotates the track 30B of the additional section. The additional section may need to be attached to the track assembly 700 in a way that enables sufficient traction between the tracks 30A and 30B and the central transmission shaft 780. While only one of the parts (rear of front) of the track assembly 700 is shown in FIGS. 14 and 15, the other part of the track assembly 700 can be similar. The two parts can be connected by a frame, such as the frame 50 or the central frame 250, as described herein.

FIGS. 16 and 17 illustrate a track assembly 800 that is modular. The track assembly 800 can include a longer track. While the track assembly 800 is illustrated without a central transmission shaft (such as, the central transmission shaft 780), it is possible to include such central transmission shaft in some implementations. The track assembly 800 can be similar to any of the track assemblies described herein. While only one of the parts (rear or front) of the track assembly 800 is shown in FIGS. 16 and 17, the other part of the track assembly 800 can be similar. The two parts can be connected by a frame, such as the frame 50 or the central frame 250, as described herein.

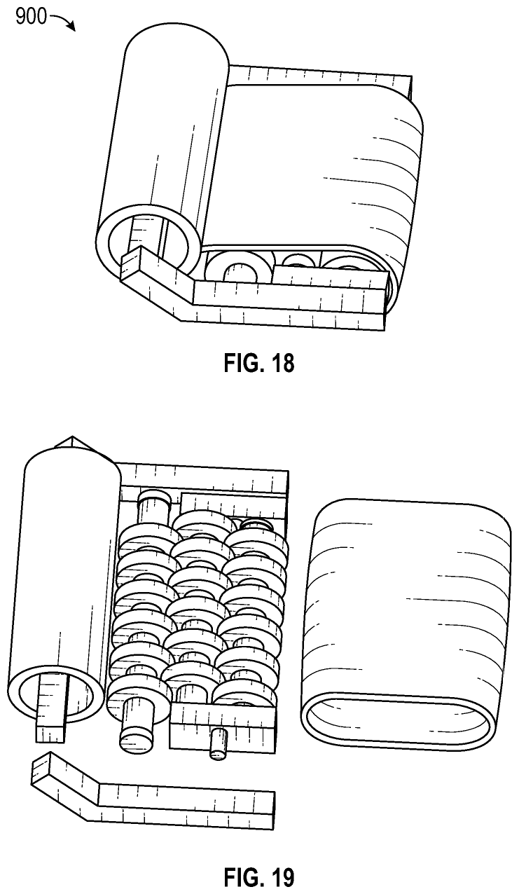

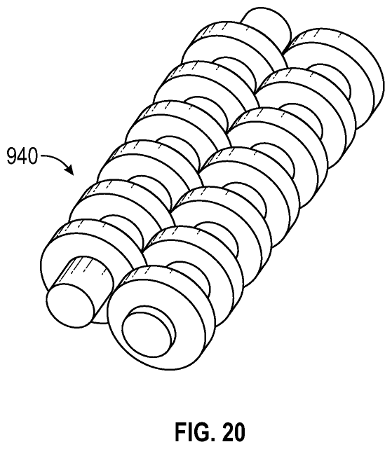

FIGS. 18 to 20 illustrate a track assembly 900 with overlapping supporting shafts 940. This can help to minimize the gap between the neighboring supporting shafts 940 and smoothen movement of a track. The track assembly 900 can be similar to any of the track assemblies described herein. While only one of the parts (rear of front) of the track assembly 900 is shown in FIGS. 18 to 20, the other part of the track assembly 900 can be similar. The two parts can be connected by a frame, such as the frame 50 or the central frame 250, as described herein.

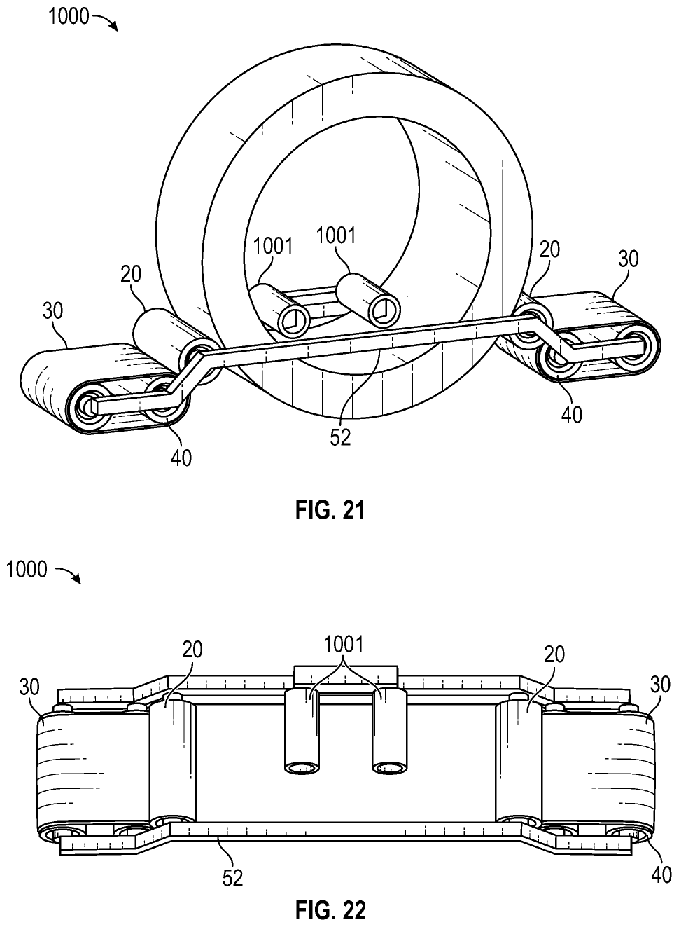

A track assembly 1000 illustrated in FIG. 21 and FIG. 22 (illustrating the top view) can be similar to the track assembly 10 and include one or more additional fixing shafts 1001 attached to the frame 50 or the central frame 250. The additional one or more fixing shafts 1001 can rotate from contact with the surface of the inner diameter of the wheel 15. The additional one or more fixing shafts 1001 can ensure that the assembly stays in place on an uneven surface, prevent detachment of the track assembly 1000 form the wheel 15, and provide additional stability especially when the wheel 15 turns (such as, changes the angle relative to the x-axis). The track assembly 1000 can be similar to any of the track assemblies described herein.

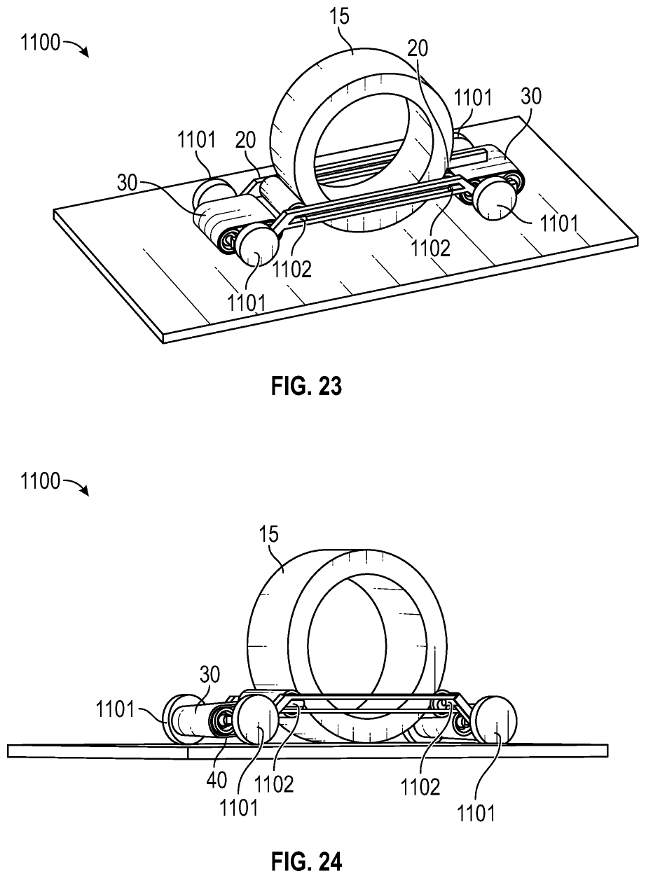

A track assembly 1100 illustrated in FIGS. 23 to 25 can be similar to the track assembly 10 and can include additional rolling wheels 1101. Such rolling wheels 1101 can keep tracks 30 above a solid surface (for example, asphalt or other type of pavement) as illustrated in FIG. 23 (showing the top perspective view) and FIG. 24 (showing the horizontal view). On the solid surface, a spring 1102 can keep distance between the transmission shafts 20 and supporting shafts 40 and can prevent tracks 30 from rotating on the solid surface. This can prolong longevity of the tracks 30 and promote reliability of the track assembly 1100.

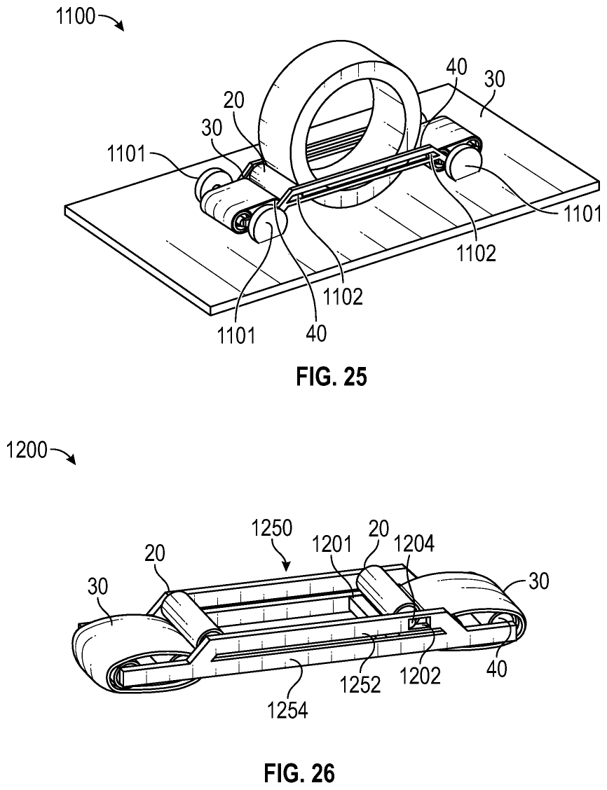

As illustrated in FIG. 25, during movement on a soft surface (such as, snow, mud, or sand), the wheel 15 can push the transmission shafts 20 towards the supporting shafts 40 and compress the springs 1102 resulting in rotation of the tracks 30. The rolling wheels 1101 are illustrated as being partially sunk into the soft surface.

A track assembly 1200 illustrated in FIG. 26 can an include an additional element 1201 of a frame 1250 that blocks rotation of a rear transmission shaft 20 when the wheel 15 rolls over the rear part of the track assembly and can make the assembly 1200 more rigid. The element 1201 can be a bar, rod, extension, or the like. The element 1201 can be attached to the frame 1250 and can extend partially or fully across the width of the frame 1250. As described herein, the element 1201 can mechanically block the rear transmission shaft 20 from rotation. The element 1201 can be positioned adjacent to the rear transmission shaft 20, such as below the transmission shaft 20. The track assembly 1200 can be similar to any of the track assemblies described herein.

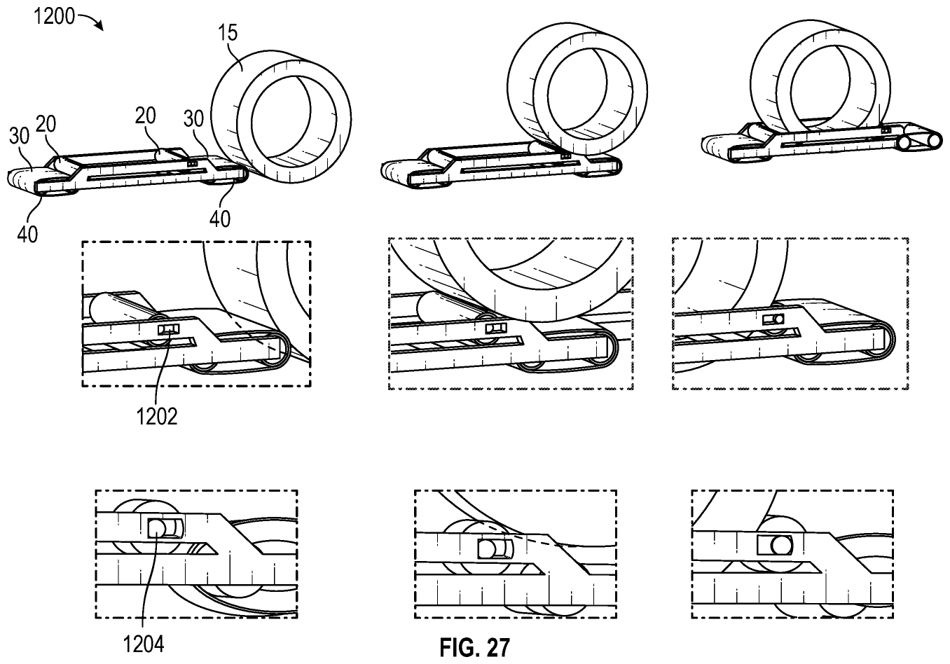

The rear transmission shaft 20 can be positioned in an opening 1202 formed in the frame 50. The opening 1202 can be a guide, cutout, groove, slit, slot, or the like. While FIG. 27 illustrates one opening 1202, a similar opening 1202 can be formed on the opposite side of the frame 50. The rear transmission shaft 20 can move laterally along the opening 1202, as described in connection with FIG. 27. For instance, the rear transmission shaft 20 can include an axle 1204 sized to facilitate lateral movement of the transmission shaft along the opening 1202. The axle 1204 can be a roller, spindle, rod, or the like. The axle 1204 can engage with the opening 1202 to facilitate movement of the rear transmission shaft 20 along the opening 1202.

The frame 1250 can be similar to the frame 50, but can include top and bottom portions 1252 and 1254. The top and bottom portions 1252 and 1254 can be bars, rods, or the like. As is illustrated, the top and bottom portions 1252 and 1254 can be connected to each other. The top portion 1252 can support the transmission shafts 20. The top portion 1252 can include the opening 1202. The bottom portion 1254 can support the element 1201 and the supporting shafts 40. In some cases, there can be a gap between the top and bottom portions 1252 and 1254, which can reduce the weight of the track assembly 1200.

FIG. 27 illustrates the sequence of installing the wheel 15 in the track assembly 1200. The left and center portions of FIG. 27 show the wheel 15 rolling over the rear part of the track assembly 1200, depicting how the rear transmission shaft 20 is being pressed against the element 1201 of the frame 1250, thereby preventing the rear transmission shaft 20 from rotating until the wheel 15 moves towards the center of the track assembly 1200 and is received in the opening. Responsive the wheel 15 rolling over the rear transmission shaft 20, the rear transmission shaft 20 moves to the left (or toward the front part of the track assembly 1200) along the opening 1202 and contacts the element 1201. In this position, the rear transmission shaft 20 is prevented from rotating. As illustrated by the right portion of FIG. 27, when the wheel 15 is situated in the opening between the front and rear transmission shafts 20 (as the result of the wheel 15 continuing to move toward the front part of the track assembly 1200), the front and rear transmission shafts 20 are being pressed by the wheel 15 against the tracks 30 and the supporting shafts 40. As a result, the rear transmission shaft 20 moves to the right along the opening 1202, and in this position the rear transmission shaft 20 can rotate. Rotation from the wheel 15 is transferred by the front and rear transmission shafts 20 to the tracks 30 and supporting shafts 40. Moving the wheel 15 from the position between the front and rear transmission shafts 20 in this or other variants of the assembly can be achieved by mechanically blocking one or more of the rear or front transmission shafts 20 from rotation. This design can facilitate installation and removal of the track assembly 1200.

Removal of the track assembly 1200 from the wheel 15 can be performed in the reverse order of the sequence illustrated in FIG. 27. The rear transmission shaft 20 can contact the element 1201 and be prevented from rotating during the removal, as described above.

In some cases, the element 1201 can be alternatively or additionally positioned at the front part of the track assembly 1200, and the front transmission shaft 20 can be configured as described above. This would be particularly advantageous in case the track assembly 1200 is symmetrical such that there is no designated front part or back part of the track assembly.

In some variations, the transmission shaft 20 (front or rear) can flex or bend when the wheel 15 rolls over the transmission shaft. In the flexed position, the transmission shaft can contact the element 1201 and be prevented from rotating. When the wheel 15 has passed the transmission shaft 20, the transmission shaft 20 can become straight and, in this position, rotate. The transmission shaft 20 can be made from suitable flexible material that allows the transmission shaft to flex and straighten without breaking.

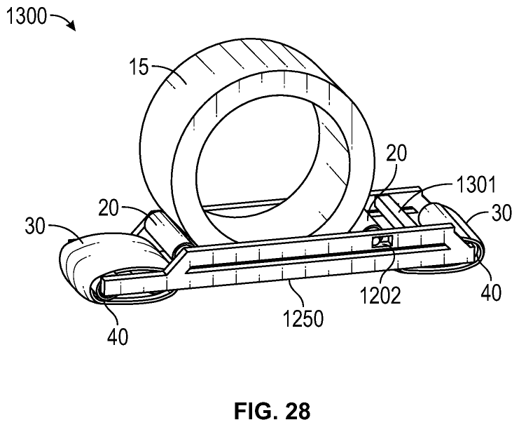

A track assembly 1300 illustrated in FIG. 28 can include an additional element 1301 of the frame 1250 that prevents the wheel 15 from pressuring (or being engaged with) the track 30 while rolling over the rear part of the track assembly. This design can make the track assembly 1300 more rigid. The track assembly 1300 can be similar to the track assembly 1200 except that unlike the element 1201, the element 1301 is positioned above the track 30. Similar to the element 1201, the element 1301 can be a bar, rod, extension, or the like. The element 1301 can attached to the frame 1350 (such as, to the top portion of the frame) and can extend partially or fully across the width of the frame 1350.

In operation, when the wheel 15 rolls over the rear part of the track assembly 1300, the element 1301 prevents the wheel 15 from contacting and rotating the track 30 until the wheel 15 moves towards the center of the track assembly 1300 and is received in the opening. When the wheel 15 is situated in the opening between the front and rear transmission shafts 20 (as the result of the wheel 15 continuing to move toward the front part of the track assembly 1300), the front and rear transmission shafts 20 are being pressed by the wheel 15 against the tracks 30 and the supporting shafts 40. As a result, the rear transmission shaft 20 moves to the right along the opening 1202, and in this position the rear transmission shaft 20 can rotate. In some implementations, the opening 1202 (and axle 1204) are omitted from the track assembly 1300.

As described in connection with the track assembly 1200, in some cases, the element 1301 can be alternatively or similarly positioned at the front part of the track assembly 1300.

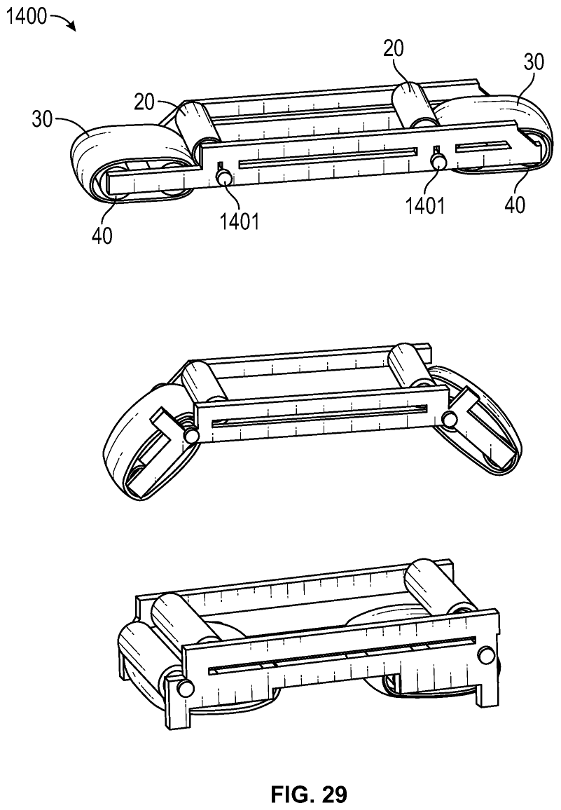

A track assembly 1400 illustrated in FIG. 29 can include one or more axles 1401 that allow folding the track assembly while it is being transported. As is illustrated, two axles 1401 can be positioned in the front and back parts of the track assembly 1400. The supporting shafts 40 supporting the tracks 30 can rotate around the axles 1401. In a fully folded configuration (illustrated at the bottom) suitable for transporting the track assembly 1400, the supporting shafts and the tracks 30 can fold to be below the transmission shafts 20. In a fully extended configuration (illustrated at the top) suitable for installing the track assembly 1400 on a wheeled vehicle. Latching mechanisms, pins, or the like can be used to facilitate transition of the track assembly 1400 from the fully folded to the fully extended configuration.

### Additional Examples

Example 1: A track assembly for a wheeled vehicle, the track assembly including:
a frame configured to receive a wheel of the wheeled vehicle;
a first plurality of shafts supported by the frame, the first plurality of shafts configured to engage with the wheel and rotate in a first direction responsive to a rotation of the wheel in a second direction opposite to the first direction;
a second plurality of shafts supported by the frame, the second plurality of shafts configured to engage with the first plurality of shafts and rotate in the second direction responsive to the rotation of the first plurality of shafts in the first direction; and
a plurality of tracks supported by the second plurality of shafts, the plurality of tracks configured to contact a surface below the wheeled vehicle and rotate in the second direction responsive to the rotation of the second plurality of shafts in the second direction thereby improving traction of the wheel,
wherein construction of the track assembly facilitates rapid installation and dismounting of the track assembly on the wheeled vehicle.

Example 2: The track assembly of example 1, wherein the frame forms an opening configured to receive the wheeled vehicle.

Example 3: The track assembly of example 2, wherein the first plurality of shafts are positioned adjacent to the opening.

Example 4: The track assembly of any of examples 1 to 3, wherein the first plurality of shafts are configured to contact the wheel, and wherein the second plurality of shafts are configured to contact the plurality of tracks.

Example 5: The track assembly of any of examples 1 to 4, further including a bar positioned adjacent to a shaft of the first plurality of shafts, the bar configured to prevent rotation of the shaft during installation of the wheel in the frame. Example 6: The track assembly of example 5, wherein the bar is positioned below the shaft.

Example 7: The track assembly of any of examples 5 to 6, wherein the shaft is configured to contact the bar responsive to the wheel rolling over the shaft thereby preventing rotation of the shaft.

Example 8: The track assembly of any of examples 5 to 7, wherein:
the frame includes a plurality of slits formed on opposite sides of the frame; and
the shaft is configured to move along the plurality of slits between a first position in which the shaft contacts the bar and is prevented from rotating and a second position in which the shaft does not contact the bar and is able to rotate.

Example 9: The track assembly of example 8, wherein the shaft is configured to transition to the first position as result of the wheel moving the shaft to contact the bar responsive to the wheel rolling over the shaft.

Example 10: The track assembly of any of examples 8 to 9, wherein the shaft is configured to transition to the second position as a result of the wheel pushing the shaft responsive to the wheel being positioned in an opening formed in the frame.

Example 11: The track assembly of any of examples 8 to 10, wherein the shaft is configured to move laterally along the plurality of slits.

Example 12: The track assembly of any of examples 8 to 11, wherein the shaft includes an axle configured to engage with the plurality of slits.

Example 13: The track assembly of any of examples 6 to 12, wherein the frame includes a top portion supporting the shaft and a bottom portion supporting the bar.

Example 14: The track assembly of any of examples 5 to 13, wherein responsive to the wheel being received in an opening of the frame, the shaft is pressed by the wheel to engage with and cause at least one shaft of the second plurality of shafts to rotate in the second direction.

Example 15: The track assembly of any of examples 1 to 4, further including a bar positioned above a track of the plurality of tracks, the bar configured to prevent rotation of the track during installation of the wheel in the frame.

Example 16: The track assembly of example 15, wherein the bar is configured to prevent the wheel from engaging with and rotating the track during installation of the wheel in the frame.

Example 17: The track assembly of any of examples 1 to 16, wherein a length of the frame is adjustable.

Example 18: The track assembly of example 17, wherein the frame includes at least one first tube and at least one second tube configured to partially fit inside the at least one first tube.

Example 19: The track assembly of any of examples 1 to 18, wherein the second plurality of shafts and the plurality of tracks are configured to transition from a folded configuration to an extended configuration.

Example 20: The track assembly of example 19, further including a plurality of axles configured to pivot the second plurality of shafts from the folded configuration to the extended configuration.

### Other Variations

Various examples of track assemblies have been disclosed. Although the track assemblies have been disclosed in the context of those examples, this disclosure extends beyond the specifically disclosed implementations to other alternative implementations and/or other uses of the implementations, as well as to certain modifications and equivalents thereof. This disclosure expressly contemplates that various features and aspects of the disclosed implementations can be combined with, or substituted for, one another. For instance, features of any of the track assemblies described herein can be combined in a particular assembly. Accordingly, the scope of this disclosure should not be limited by the particular disclosed implementations described above.

It will be appreciated by those skilled in the art that various modifications and changes can be made without departing from the scope of the described implementations. Such modifications and changes are intended to fall within the scope of the disclosed implementations. It will also be appreciated by those of skill in the art that parts included in one implementation are interchangeable with other implementations; one or more parts from a depicted implementation can be included with other depicted implementations in any combination. For example, any of the various components described herein and/or depicted in the figures can be combined, interchanged, or excluded from other implementations.

The use of particular terminology when describing certain features or aspects of the disclosure should not be taken to imply that the terminology is being redefined herein to be restricted to including any specific characteristics of the features or aspects of the technology with which that terminology is associated.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

Directional terms used herein (for example, top, bottom, side, up, down, inward, outward, etc.) are generally used with reference to the orientation or perspective shown in the figures and are not intended to be limiting. For example, positioning “above” described herein can refer to positioning below or on one of sides. Thus, features described as being “above” may be included below, on one of sides, or the like.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations).

The term “comprising” as used herein is synonymous with “including,” “containing,” or “characterized by,” and is inclusive or open-ended and does not exclude additional, unrecited elements or method steps.

Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations or that one or more implementations necessarily include logic for deciding, with or without user input or prompting, whether these features, elements, and/or steps are included or are to be performed in any particular implementation.

Language of degree used herein, such as the terms “approximately,” “about,” “generally,” and “substantially” as used herein represent a value, amount, or characteristic close to the stated value, amount, or characteristic that still performs a desired function and/or achieves a desired result. For example, the terms “approximately”, “about”, “generally,” and “substantially” may refer to an amount that is within less than 10% of, within less than 5% of, within less than 1% of, within less than 0.1% of, and/or within less than 0.01% of the stated amount.

It will be further understood by those within the art that any disjunctive word and/or phrase presenting two or more alternative terms, whether in the description, claims, or drawings, can be understood to contemplate the possibilities of including one of the terms, either of the terms, or both terms. For example, the phrase “A or B” will be understood to include the possibilities of “A” or “B” or “A and B.” Further, the term “each,” as used herein, in addition to having its ordinary meaning, can mean any subset of a set of elements to which the term “each” is applied.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

The above description discloses implementations of systems, apparatuses, devices, methods, and materials of the present disclosure. This disclosure is susceptible to modifications in the components, parts, elements, steps, and materials, as well as alterations in the fabrication methods and equipment. Such modifications will become apparent to those skilled in the art from a consideration of this disclosure or practice of the disclosure. Consequently, it is not intended that the disclosure be limited to the specific implementations disclosed herein, but that it cover all modifications and alternatives coming within the scope and spirit of the subject matter embodied in the following claims.

What is claimed is:

1. A track assembly for a wheeled vehicle, the track assembly comprising:
a frame configured to receive a wheel of the wheeled vehicle;
a first plurality of shafts supported by the frame, the first plurality of shafts configured to engage with the wheel and rotate in a first direction responsive to a rotation of the wheel in a second direction opposite to the first direction;
a second plurality of shafts supported by the frame, the second plurality of shafts configured to engage with the first plurality of shafts and rotate in the second direction responsive to the rotation of the first plurality of shafts in the first direction; and
a plurality of tracks supported by the second plurality of shafts, the plurality of tracks configured to contact a surface below the wheeled vehicle and rotate in the second direction responsive to the rotation of the second plurality of shafts in the second direction thereby improving traction of the wheel,
wherein construction of the track assembly facilitates rapid installation and dismounting of the track assembly on the wheeled vehicle.

2. The track assembly of claim 1, wherein the frame forms an opening configured to receive the wheeled vehicle.

3. The track assembly of claim 2, wherein the first plurality of shafts are positioned adjacent to the opening.

4. The track assembly of claim 1, wherein the first plurality of shafts are configured to contact the wheel, and wherein the second plurality of shafts are configured to contact the plurality of tracks.

5. The track assembly of claim 1, further comprising a bar positioned adjacent to a shaft of the first plurality of shafts, the bar configured to prevent rotation of the shaft during installation of the wheel in the frame.

6. The track assembly of claim 5, wherein the bar is positioned below the shaft.

7. The track assembly of claim 6, wherein the shaft is configured to contact the bar responsive to the wheel rolling over the shaft thereby preventing rotation of the shaft.

8. The track assembly of claim 7, wherein:
the frame comprises a plurality of slits formed on opposite sides of the frame; and
the shaft is configured to move along the plurality of slits between a first position in which the shaft contacts the bar and is prevented from rotating and a second position in which the shaft does not contact the bar and is able to rotate.

9. The track assembly of claim 8, wherein the shaft is configured to transition to the first position as result of the wheel moving the shaft to contact the bar responsive to the wheel rolling over the shaft.

10. The track assembly of claim 9, wherein the shaft is configured to transition to the second position as a result of the wheel pushing the shaft responsive to the wheel being positioned in an opening formed in the frame.

11. The track assembly of claim 8, wherein the shaft is configured to move laterally along the plurality of slits.

12. The track assembly of claim 8, wherein the shaft comprises an axle configured to engage with the plurality of slits.

13. The track assembly of claim 6, wherein the frame includes a top portion supporting the shaft and a bottom portion supporting the bar.

14. The track assembly of claim 5, wherein responsive to the wheel being received in an opening of the frame, the shaft is pressed by the wheel to engage with and cause at least one shaft of the second plurality of shafts to rotate in the second direction.

15. The track assembly of claim 1, further comprising a bar positioned above a track of the plurality of tracks, the bar configured to prevent rotation of the track during installation of the wheel in the frame.

16. The track assembly of claim 15, wherein the bar is configured to prevent the wheel from engaging with and rotating the track during installation of the wheel in the frame.

17. The track assembly of claim 1, wherein a length of the frame is adjustable.

18. The track assembly of claim 17, wherein the frame comprises at least one first tube and at least one second tube configured to partially fit inside the at least one first tube.

19. The track assembly of claim 1, wherein the second plurality of shafts and the plurality of tracks are configured to transition from a folded configuration to an extended configuration.

20. The track assembly of claim 19. further comprising a plurality of axles configured to pivot the second plurality of shafts from the folded configuration to the extended configuration.
